(19) United States
(12) Patent Application Publication
(10) Pub. No.: US 2026/0321850 A1
(43) Pub. Date: Oct. 15, 2026

(54) BATTERY MODULE, METHOD FOR ASSEMBLING BATTERY MODULE, AND BATTERY PACK INCLUDING PLURALITY OF BATTERY MODULES

(71) Applicant: Samsung SDI Co., Ltd., Yongin-si (KR)

(72) Inventor: Dominik MARESCH, Hausmannstaetten (AT)

(21) Appl. No.: 19/439,939

(22) Filed: Jan. 5, 2026

(30) Foreign Application Priority Data
Apr. 15, 2025 (EP) 25170622.2

(51) Int. Cl. H01M 50/258; H01M 50/209

(52) U.S. Cl. CPC H01M 50/258; H01M 50/209

(57) ABSTRACT

A battery module includes: a battery cell stack including battery cells stacked in a stacking direction between a first end side and a second end side; a module wall including two oppositely arranged side walls extending along the stacking direction with the battery cell stack arranged therebetween and an end wall on the first end side of the battery cell stack and connecting the two side walls to each other; and a first end plate on the second end side of the battery cell stack and opposite the end wall. Each of the side walls is connected to the first end plate by a form-fit sliding connection, and a sliding direction of the form-fit sliding connection is perpendicular to the stacking direction.

### CROSS-REFERENCE TO RELATED APPLICATION

The present application claims priority to and the benefit of European Patent Application No. 25170622.2, filed on Apr. 15, 2025, in the European Patent Office, the entire disclosure of which is incorporated herein by reference.

### BACKGROUND

### 1. Field

Aspects of embodiments of the present disclosure relates to a battery module, a method for assembling the battery module, and a battery pack including a plurality of the battery modules.

### 2. Description of the Related Art

A battery module is formed of a plurality of battery cells connected together in series or in parallel. For example, the battery module is formed by interconnecting the electrode terminals of the plurality of battery cells in a number and/or configuration depending on a desired amount of power and to realize a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected in series to provide a desired voltage.

A battery pack is a set of any number of (usually identical) battery modules or single battery cells. The battery modules, and respectively the battery cells therein, may be configured in a series, parallel, or a mixture of both to provide the desired voltage, capacity, and/or power density. Components of a battery pack include the individual battery modules and the interconnects, which provide electrical conductivity between the battery modules.

Mechanical integration of a battery pack is achieved by appropriate mechanical connections between the individual components, for example, between the battery modules and between them and a supporting structure of the vehicle. These connections should remain functional and safe during the average service life of the battery system. Further, installation space and interchangeability specifications should be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors, such as bolts or screws. In some cases, the battery modules are confined by fastening side plates to lateral sides of the carrier framework. Further, cover plates may be fixed atop and below the battery modules.

The carrier framework of the battery pack is mounted to a carrying structure of the vehicle. When the battery pack is to be fixed at the bottom of the vehicle, the mechanical connection may be established from the bottom side by, for example, bolts passing through the carrier framework of the battery pack. The framework is generally made of aluminum or an aluminum alloy to reduce the overall weight of the construction.

The battery cell stack/module should be designed so that it can withstand the so-called "swelling forces" caused by internal chemical processes in the cells themselves during operation. Forces up to about 40kN and more should be anticipated and resisted.

It is common to fix end plates by conventional (e.g., laser) welding methods. An appropriately designed overlap area is necessary to handle different compression length values. Alternative mechanical fixing methods, such as conventional screw fixing in combination with longitudinal drilling, are usually not economically feasible for reasons of space and are technically unacceptable with regard to the transmission of high shear forces due to the relative movement of the clamped parts.

Typically, cell modules are designed so that all contained parts should be protected against corrosion, depending on the application. Therefore, a rust-resistant and weldable material may be selected because a previously applied coating may be burned away after the welding process.

Common materials for the plates, such as stainless steel and aluminum, have relatively low yield strength values, which means that the parts have to have increased wall thickness to increase the loaded cross-sectional area in order to be able to transmit all mechanical stresses and loads, especially swelling forces. This leads to lower packing efficiency and generally higher costs, for example, the part weight increases due to the lower mechanical strength. With conventional steel, on the other hand, an appropriate antirust coating must be applied. Welding is then no longer possible or only in combination with a subsequently applied coating, which is not cost-efficient because welding damages the coating.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a battery module includes a battery cell stack including battery cells stacked in a stacking direction between a first end side and a second end side, a module wall, an end wall, and a first end plate. The module wall includes two oppositely arranged side walls extending along the stacking direction between which the battery cell stack is arranged, and the end wall is arranged on the first end side of the battery cell stack and connects the two side walls to each other. The first end plate is arranged on the second end side of the battery cell stack and opposite the end wall. Each of the side walls is connected to the first end plate by a form-fit sliding connection, and a sliding direction of the form-fit sliding connection is perpendicular to the stacking direction.

According to another embodiment of the present disclosure, a method for assembling a battery module includes: providing a battery cell stack including battery cells stacked in a stacking direction between a first end side and a second end side; providing a module wall including two side walls arrangeable on opposite sides of the battery cell stack and extending along the stacking direction and an end wall arrangeable on the first end side of the battery cell stack and connecting the two side walls to each other; compressing the battery cell stack; arranging the battery cell stack between the side walls of the module wall; providing a first end plate arrangeable on the second end side of the battery cell stack and opposite the end wall and connectable to the two side walls by a form-fit sliding connection having a sliding direction perpendicular to the stacking direction; and establishing the form-fit sliding connection with the two side walls by sliding the first end plate along the sliding direction.

Yet another embodiment of the present disclosure refers to a battery pack including a plurality of battery modules as described above, configured in a series, parallel, or a mixture of both to deliver a desired voltage and current, a battery management system (BMS), and a cooling circuit.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic perspective view of a battery module according to an embodiment.

FIG. 2A is a schematic perspective view of a battery module according to another embodiment.

FIG. 2B illustrates the battery module shown in FIG. 2A in a top view.

FIG. 2C is an enlarged view of a form-fit sliding connection shown in FIG. 2B in a top view.

FIG. 2D illustrates a schematic structure of the battery module shown in FIG. 2A in partially exploded view.

FIG. 3A illustrates an arrangement during a method for assembling a battery module according to some embodiments.

FIG. 3B is a flow chart describing a method for assembling a battery module according to some embodiments.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary to those of ordinary skill in the art to have a complete understanding of the aspects and features of the present disclosure may not be described or may be only briefly described. In the drawings, the relative sizes of elements, layers, and regions may be exaggerated for clarity.

As used herein, the term "and/or" includes any and all combinations of one or more of the associated listed items. The same reference numerals designate the same elements. Further, the use of “may” when describing embodiments of the present disclosure refers to “one or more embodiments of the present disclosure." In the following description of embodiments of the present disclosure, the terms of a singular form may include plural forms unless the context clearly indicates otherwise. Expressions, such as “at least one of” and “any one of,” when preceding a list of elements, modify the entire list of elements and do not modify the individual elements of the list. For example, the expression "at least one of a, b, or c" indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that although the terms "first" and "second" are used to describe various elements, these elements should not be limited by these terms. These terms are only used to distinguish one element from another element. For example, a first element may be named a second element and, similarly, a second element may be named a first element, without departing from the scope of the present disclosure. As used herein, the term “and/or” includes any and all combinations of one or more of the associated listed items. Expressions such as “at least one of,” when preceding a list of elements, modify the entire list of elements and do not modify the individual elements of the list.

As used herein, the term "substantially," "about," and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/- about 5% of the value centered on the value.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being "above" or "on" another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, for example, on a PCB or another kind of circuit carrier. The conducting elements may include metallization, such as surface metallizations and/or pins, and/or may include conductive polymers or ceramics. Further, electrical energy might be transmitted via wireless connections, for example, by using electromagnetic radiation and/or light.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media, such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification and should not be interpreted in an idealized or overly formal sense unless expressly so defined herein.

According to an embodiment of the present disclosure, a battery module includes a battery cell stack including battery cells stacked in a stacking direction between a first end side and a second end side. The battery module further includes a module wall, an end wall, and a first end plate. The module wall includes two oppositely arranged side walls extending along the stacking direction with the battery cell stack arranged therebetween. The end wall is arranged on the first end side of the battery cell stack and connects the two side walls (to each other). The first end plate is arranged on the second end side of the battery cell stack and opposite the end wall. Each of the side walls is connected to the first end plate by a form-fit sliding connection having a sliding direction perpendicular to the stacking direction.

A battery module may be provided with at least one battery cell stack including a plurality of battery cells stacked along a stacking direction. The battery module may include a module wall partially enclosing the at least one battery cell stack. The module wall may include two side walls extending along the stacking direction on opposite sides of the battery cell stack and an end wall connecting the two side walls to each other at a first stacking end side of the battery cell stack. The battery module may also include a first end plate arranged on a second stacking end side of the battery cell stack opposite to the end wall, and the first end plate may be connected to the module wall by a form-fit sliding connection having a sliding direction perpendicular to the stacking direction.

The end wall of the module wall may be adjacent to the first stacking end side of the battery cell stack and may form a receiving surface for the battery cell stack. The end wall may include high strength sheet metal, for example, steel.

The side walls may form lateral boundaries for the battery cell stack and may house (or accommodate) the battery cells. The side walls may include high strength sheet metal, for example, steel.

The first end plate may extend perpendicular to the stacking direction.

According to an embodiment, one or both side walls have a support surface on an underside or upper side of the battery cell stack extending along the stacking direction. For example, one or both of the side walls have an area extending perpendicular to the stacking direction and along the stacking direction to form a receptacle having, for example, a rectangular shape on which the battery cells are stored. The support surface may extend between both side walls. The battery cells may still be arranged for assembly between the side walls from the other side, which does not have such a support surface, while at the same time being positioned in the desired position by the support surface. The support surfaces of one or both side walls may connect the two side walls or may form a gap extending between the support surfaces such that they do not connect the side walls.

According to another embodiment, the battery module includes a second end plate arranged on the first end side of the battery cell stack adjacent to the end wall and opposite the first end plate and between both above-mentioned components. The second end plate distributes swelling forces, may have high stiffness, and may include, for example, steel. The second end plate can prevent or reduce end cell damage due to squeezing initiated by cell swelling. The second end plate may be designed corresponding to the first end plate and, accordingly, may have the features of the various disclosed embodiments.

According to another embodiment, the battery module includes spacers disposed between adjacent pairs of battery cells.

The first end plate and/or the second end plate may include module mounting points, which allows easy mounting, for example, with frames or other structures. The module mounting points may be openings that extend perpendicular to the stacking direction through the respective plate and parallel to the side walls.

The module wall provides a simplified assembly process that eliminates the need for a screwing or welding process. This can reduce effort and costs, as well as errors, during screwing or welding.

Accordingly, a battery module is provided that saves costs and installation space. Due to the sliding connection, a joining process, such as welding or screwing, may be omitted. Accordingly, the use of stainless steel or aluminum can be dispensed with for the first and second end plates as well as for the module wall because a coating can now be provided for the mentioned components. Such a coating is not damaged due to the lack of welding, so there is permanent corrosion protection.

In addition, materials may be used for the end plates that have advantageous mechanical properties. The first and second end plates, the end wall, and/or the side walls may include steel, for example, high-strength steels. These have higher yield strengths than aluminum or stainless steel and have higher strength. This in turn allows the first and second end plates, the end wall, and side walls to be thinner-walled, enabling smaller dimensions of the battery modules as well as lower weight. Also, openings, for example, to connect electrical poles (e.g., terminals), would pose significant stability and strength problems in the case of stainless steels compared with high-strength steels. Furthermore, steel is considerably less expensive than aluminum or stainless steel.

Furthermore, all mechanical design considerations, for example, resistance to swelling forces, are met and the connecting mechanism allows easy connection of the first and second end plates to one or both side walls. Furthermore, the accessibility of suitable tools and equipment as well as a simple and cost-effective joining process is ensured.

According to another embodiment, the module wall includes a U-shaped module wall at least partially enclosing the battery cell stack. Such a module wall is a suitable form for the simple arrangement of the battery cells, whereby only a free side opposite the end wall is to be closed by the first end plate.

According to another embodiment, each of the side walls is connected to the end wall by a form-fit sliding connection having a sliding direction perpendicular to the stacking direction. Accordingly, the end wall is also connected by the form-fit sliding connection so that the above-mentioned advantages can be achieved on both sides and a high degree of flexibility is achieved during assembly.

According to another embodiment, the form-fit sliding connection is continuous between two opposite side edges of each of the side walls extending along the stacking direction, respectively. For example, the connection between each of the side walls with the first end plate and/or the second end plate extends along a complete (e.g., the entire) height of a side wall. As a result, the form-fit sliding connection is present over the maximum possible area of each side wall, which results in improved force and stress distribution. When the form-fit sliding connection is limited to the area of the side wall, high local stress can occur, which should be avoided.

According to another embodiment, a first end of each of the side walls is connected to the first end plate by the form-fit sliding connection and/or a second end of each of the side walls is connected to the end wall by the form-fit sliding connection. The second end of each of the side walls may additionally or alternatively be connected to the second end plate by the form-fit sliding connection. The end connection simplifies the production of a corresponding module wall and utilizes the maximum space provided by the outer contour of the module wall.

According to another embodiment, the module wall is an integrally formed single piece. This simplifies the production of a module wall. For example, the module wall may be formed from a semi-finished product simply by bending it into a corresponding shape. Furthermore, welding seams or screw connections are reduced, which reduces assembly work and further reduces the number of possible weak points. In addition, uniform force distribution is improved when swelling forces occur. This provides a module wall for a simplified assembly process that eliminates the need for a screwing or welding process in the end wall. The above-mentioned advantages also apply to the side walls and the end wall. The one-piece design eliminates the need to assemble the side walls and the end wall, as well as the second end plate, while the sliding mechanism for connecting the first end plate to the module wall considerably simplifies and guarantees assembly. This can reduce effort and costs, as well as errors, during screwing or welding.

According to another embodiment, the form-fit sliding connection is formed between a cavity and a fluidly connected slit of the first end plate, both extending perpendicular to the stacking direction, and a thickened end portion of each of the side walls. The thickened end portions are slidably accommodated inside the corresponding cavity while the side walls extend through the corresponding slit. For example, the first end plate may have at least two slits arranged on opposite sides of the first end plate, which are either both connected to one cavity extending between the slits or, alternatively, may have at least two slits arranged on opposite sides of the first end plate, both of which are connected to a respective cavity, therefore also including at least two cavities. For example, the cavity and the slit extend perpendicular to the stacking direction and parallel to the side walls and form an opening running (or extending) through the first end plate. Furthermore, the side walls are shaped such that they have one area that can extend through the slit and another area connected to the one area that does not fit through this slit so that the connection is achieved. There may be a single cavity, with the first end plate then having a corresponding slit on each side facing the corresponding side wall, in other words, two slits extending in opposite directions from the cavity to the respective side wall. The first end plate may also include separate cavities with a separate slit on each side facing the corresponding side wall, in other words, may have two cavities and two slits, each pair of which forms a connection with the corresponding side wall. The cavity may have different cross-sectional shapes with respect to the direction in which the cavities extend, for example, rectangular, square, circular, elliptical, triangular, or polygonal.

According to another embodiment, a portion of at least one of the side walls including the respective thickened end portion is bent such that the bent portion is inclined with respect to the stacking direction. The bent portion may be inclined such that the bent portion extends perpendicular to the stacking direction. For example, the portion of the side walls extending through the slits and the portion of the side walls including the thickened end portions may extend with an angle in a range between more than 0° and 90° or less degrees such that a portion of the respective side wall including this portion is disposed inside a space formed by the side walls extending in the stacking direction. The angle may be more than about 25° degrees and may be more than about 45° degrees. The angle may be in a range between about 80° and about 90° degrees.

According to another embodiment, at least one bent portion is connected to a non-bent portion of the corresponding side wall by a connecting element, for example, a rib or strut, on an under side or upper side of the battery cell stack extending between both side walls. For example, a connecting element is arranged on the top side or under side of the battery cell stack and connects a region of the respective side wall that forms the form-fit sliding connection with the first end plate and a region of the respective side wall that is not involved in the form-fit sliding connection with the first end plate and extends along the stacking direction, thereby distributing stresses that act on the region of the form-fit sliding connection to other regions of the respective side wall so that the form-fit sliding connection is relieved and stability is increased.

According to another embodiment, the thickened end portion is a material thickening and/or geometric thickening. For example, the thickened end portion includes a material configuration or geometrical (structural) configuration that may be formed by a configuration of the side walls in the corresponding area or by configuring a geometric or structural shape of the corresponding area. For example, the side walls in the corresponding area have a locally increased volume of material so that this area has an increased cross-section with respect to a direction perpendicular to the stacking direction. Further, the side walls in the corresponding area may have a locally changed structure or shape, which is also accompanied by an increased cross-section. In the material configuration, the thickening is achieved, for example, by a local increase in the material of the side walls. In other words, the cross-section is increased in relation to a direction perpendicular to the stacking direction of the side walls in the thickened end portions. In the geometric or structural configuration, the corresponding area of the side walls is achieved by shaping the side walls accordingly.

According to another embodiment, the geometric thickening of the thickened end portion includes a spirally wound area (or part) of the side wall. This shape is particularly easy to achieve, for example, a first end of each of the side and/or a second end of each of the side walls may have corresponding spiral windings. According to embodiments of the present disclosure, these spiral windings are then arranged within the cavities, and non-wound areas of the side walls can extend through the slit. The spiral windings offer a further advantage. Due to the swelling forces and elongation of the battery cells, forces on the spacer and/or the module wall can occur along a positive or negative stacking direction. The spiral windings form a spring-like element that can change its cross-sectional area when the battery cell stack and the side walls change length. In other words, there is an element similar to a coil spring, whereby the distances between the spiral windings increase or decrease depending on the change in length of the battery cell stack and the side walls. This compensates for a certain change in length and, from a certain point, provides a corresponding counteracting spring force that counteracts any further change in length. So, at the same time, the tolerance-related differences in dimensions in the stacking direction are considered, as the connection system allows the distance between the first end plate and the second end plate or between the end wall and the first end plate to be adjusted.

According to another embodiment, the side walls, the module wall, and/or the first end plate includes a locking element that is configured to block displacement of the first end plate in the direction of the sliding direction when a form-fit sliding connection is established. The locking element can prevent the first end plate from leaving its position when assembled. During operation, for example, when used in a vehicle or similar, movement and/or vibrations can occur that subject the first end plate to forces that could move it out of position. The locking element is provided to counteract this.

According to another embodiment, the locking element is pivotable from a first position to a second position about a pivot axis, which is perpendicular to the stacking direction, such that, in the first position, the first end plate is displaceable, and in the second position, the first end plate is fixed (e.g., is not displaceable). This provides a locking element that is particularly easy to operate and enables assembly and subsequently prevents the first end plate from moving by itself. The locking element may be a rectangular plate or a rod-shaped strut, which may be connected to one of the side walls and, in the first position, extends along the stacking direction and may not overlap a surface extending between the opposing side walls so that assembly remains possible. In the second position, the locking element is pivoted in such a way that it overlaps at least one upper edge of the first end plate, which extends between the opposing side walls in the assembled state so that movement is prevented. The locking element may also be connected to the first end plate. It may have a hook-shaped end section which, after pivoting into the second position, engages in a receiving element arranged on one of the side walls or the first end plate, such as an eyelet or a corresponding hook. Several locking elements may be provided, whereby, for example, two locking elements are arranged on opposite sides of the battery cell stack, respectively, whereby a lower edge of the first end plate, which in the assembled state extends between the opposite side walls, also overlaps such that movement in both positive and negative directions perpendicular to the stacking direction is prevented. The locking element may be arranged on a side wall, whereby it may be then arranged in an area that lies between the first and the second end side of the battery cell stack. The locking element may be rotatably connected to the side wall, whereby other directions of movement are blocked so that, in the second position, the movement of the first end plate is blocked by the overlapping locking element.

According to another embodiment, the battery module includes two battery cell stacks and two module walls. The first end plate is arranged between the two battery cell stacks, and the first end plate is connected to each of the side walls of the respective module walls by the form-fit sliding connection. In other words, the arrangement of the battery cell stack with battery cells stacked between the first and the second end sides in the stacking direction and the module wall, which includes the two oppositely arranged side walls extending along the stacking direction and between which the battery cell stack is arranged, and the end wall arranged on the first end side of the battery cell stack and connecting the two side walls (to each other), is present on both opposite sides of the one first end plate. In other words, the battery cells of the respective battery cell stack both extend along the same stacking direction but each have a different orientation (positive and negative direction) so that they meet at the first end plate and are separated from the same. Each of the side walls of the respective module wall is connected to the first end plate by the form-fit sliding connection. In other words, the first end plate is connected on a first side to the side walls of one of the two module walls by the form-fit connection and is connected on a second side to the side walls of the other of the two module walls by the form-fit connection. Accordingly, the first end plate may be designed symmetrically. The embodiments of the first end plate described above may also be designed in duplicate or in such a way that they form the connection with both the side walls of one of the two module walls and the other of the module walls. In other words, for example, the slit and the cavity may be double and separate from each other or may be single and form the connection with all of the side walls. The first end plate may be a middle plate of the battery module. The high-voltage systems of most current electric vehicles are operated at a voltage level of around 400 volts. Over the years, 400 volts has established itself as the quasi-industry standard. Currently, 800-volt technology is also being used more and more frequently, meaning that a further standard is anticipated in the future. By using the first end plate as a middle plate, a battery module is provided that enables a particularly simple structure and, by using two stacks of 400 volts each, a mode of operation at 400 volts or 800 volts is possible. For this purpose, the two battery cell stacks are connected in parallel to achieve 400-volt operation and in series to achieve 800-volt operation. Both charging/discharging, especially in bank charging, in which one “side” of the battery module is charged or discharged, and operation can be carried out at either 400 volts or 800 volts.

According to another embodiment, the first end plate includes a recess. The recess may extend perpendicular to the stack direction. This can save material.

According to another embodiment, the first end plate houses (or accommodates) battery module management electronics for the battery module. In other words, the first end plate has areas or spaces that are configured to accommodate battery module management electronics. The first end plate then acts as a space-saving option for the arrangement of these components and also protects these components. The first end plate may have a high degree of rigidity so that it provides appropriate mechanical protection for these sensitive components. For example, one or more cavities may be provided that extend in a direction perpendicular to the stacking direction, in other words, between two opposing outer surfaces of the first end plate. The cross-section of such a cavity may be rectangular, triangular, polygonal, circular, or elliptical, with a shape and dimensions selected that affect the stability as little as possible. The cavities for the arrangement of the component may be separate from areas of the first end plate that are involved in the form-fit sliding connection, for example, separate from the cavities and slits. The first end plate may have a central area arranged centrally between two sides of the first end plate, which extends perpendicular to the stacking direction and remains free of receiving areas or hollow spaces, in other words, has continuous first end plate material, as this maintains its stability despite further adjacent or nearby receiving areas or hollow spaces. The central area may include a connecting bar that connects the several optional cavities for the housing function.

According to another embodiment of the present disclosure, a method for assembling a battery module is provided. The method for assembling a battery module includes providing a battery cell stack including battery cells stacked in a stacking direction between a first end side and a second end side and providing a module wall, the module wall including two side walls arrangeable on opposite sides of the battery cell stack and extendable along the stacking direction, and an end wall arrangeable on the first end side of the battery cell stack and connecting the two side walls (to each other). Further, the method includes compressing the battery cell stack and arranging the battery cell stack between the side walls of the module wall. Further, a first end plate, which is arrangeable on the second end side of the full cell stack and opposite the end wall and connectable to the two side walls by a form-fit sliding connection having a sliding direction perpendicular to the stacking direction, is provided. The form-fit sliding connection with the two side walls is established by sliding the first end plate along the sliding direction.

Yet another embodiment of the present disclosure refers to a battery pack. The battery pack includes a plurality of battery modules as described above, configured in a series, parallel, or a mixture of both to deliver a desired voltage and current, a battery management system (BMS), and a cooling circuit.

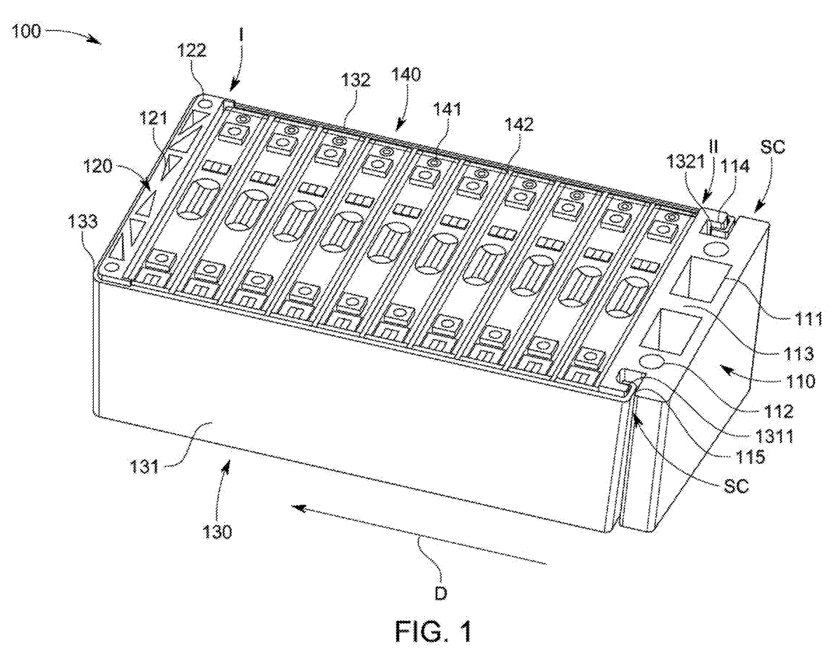

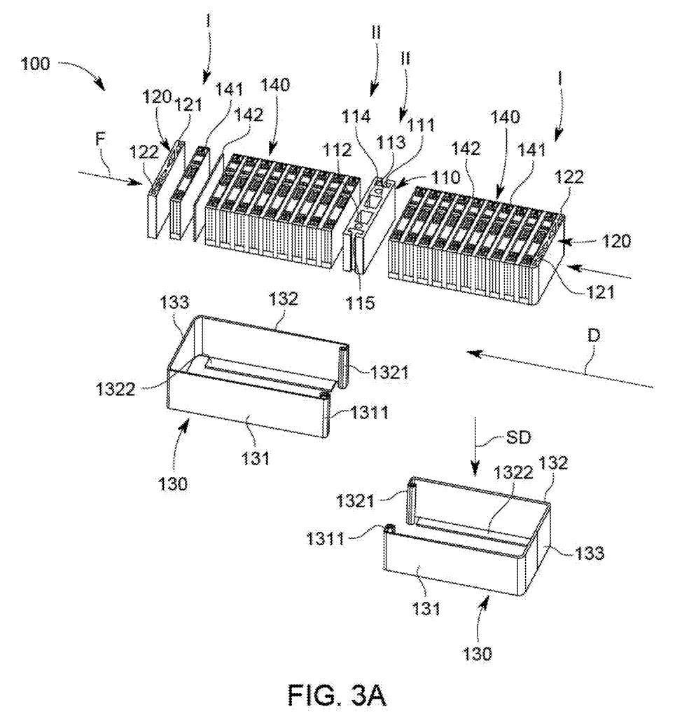

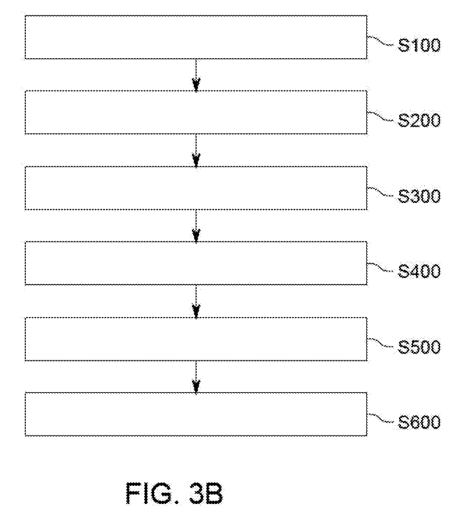

FIG. 1 is a schematic perspective view of a battery module 100 according to an embodiment. The battery module 100 includes a battery cell stack 140 with battery cells 141 stacked between a first end side I and a second end side II in a stacking direction D. A spacer 142 is arranged between a pair of (e.g., between adjacent ones of) battery cells 141. The battery module 100 includes a module wall 130, and the module wall 130 includes two oppositely arranged side walls 131, 132 and an end wall 133. The first side wall 131 and the second side wall 132 both extend along the stacking direction D with the battery cell stack 140 arranged therebetween, and the end wall 133 is arranged on the first end side I of the battery cell stack 140 and connects the two side walls 131, 132. A first end plate 110 is arranged on the second end side II of the battery cell stack 140 and opposite the end wall 133, and each of the side walls 131, 132 is connected to the first end plate 110 by a form-fit sliding connection SC. A sliding direction SD of the form-fit sliding connection SC (see, e.g., FIG. 3A) extends perpendicular to the stacking direction D. In addition, the battery module 100 includes a second end plate 120 disposed on the first end side I of the battery cell stack 140 adjacent the end wall 133 and opposite the first end plate 110.

The illustrated battery module 100 includes two opposing side walls 131, 132, the first side wall 131 and the second side wall 132, with the first and second end plates 110, 120 disposed at their first and second ends, respectively, which also oppose each other and are oriented orthogonally to the side walls 131, 132. A plurality of individual battery cells 141 are disposed between the first and second end plates 110, 120 along the stacking direction D. Spacers 142 may be disposed between the cells 141, as well as intermediate layers.

In the illustrated embodiments, the module wall 130 is integrally formed in one piece and has a U-shape but in other embodiments may be multi-part component.

The first end plate 110 has two recesses 111, which extend perpendicular to the stacking direction D in the first end plate 110. Both recesses 111 have a rectangular cross-section but may also be realized in other shapes. The two recesses 111 are separated from each other with a central area, for example, a connecting bar 113, therebetween. One or both recesses 111 may accommodate electronic components. The recesses 111 allow for material to be saved while a reduction in the strength of the first end plate 110 due to the connecting bar 113 is counteracted. In addition, the first end plate 110 includes two mounting holes (or openings) 112 arranged opposite one another, to fasten the battery module 100 to other structures, for example, with a screw or bolt. The first end plate 110 has two slits 115, each of which extends from an outer surface of the first end plate 110 along the entire height of the first end plate 110 and perpendicular to the stacking direction D. The slits 115 each open into a cavity 114, which may have a rectangular cross-sectional shape, although other shapes are possible. In the illustrated embodiment, the cavity 114 has a greater width in the stacking direction D than the slit 115.

The second end plate 120 includes a plurality of recesses 121, which extend perpendicular to the stacking direction D through the second end plate 120. The recesses 121 have a triangular cross-section but may be realized in other shapes. The recesses 121 are separated from each other with material of the second end plate 120 therebetween. The recesses 121 may accommodate electronic components. In any case, the recesses 121 allow for material to be saved. In addition, the second end plate 120 includes two mounting holes (or openings) 122 arranged opposite one another, to fasten the battery module 100 to other structures, for example, with a screw or bolt.

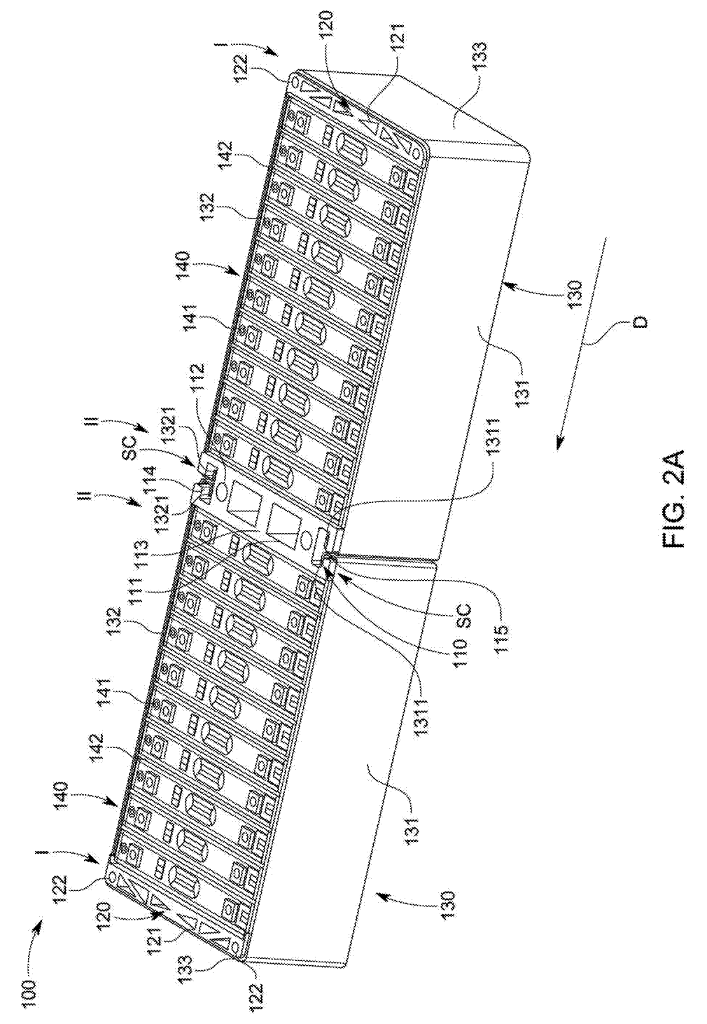

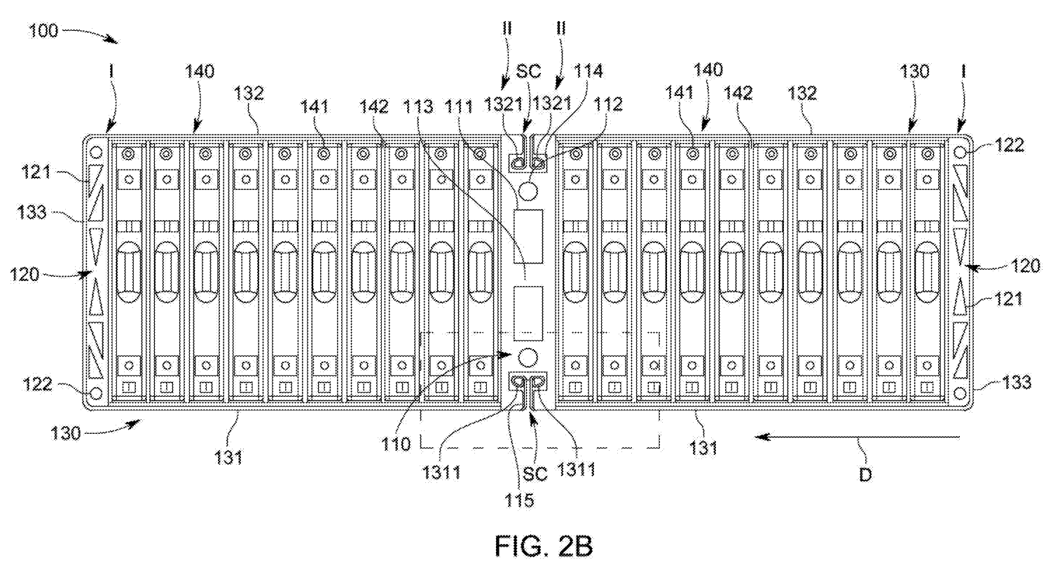

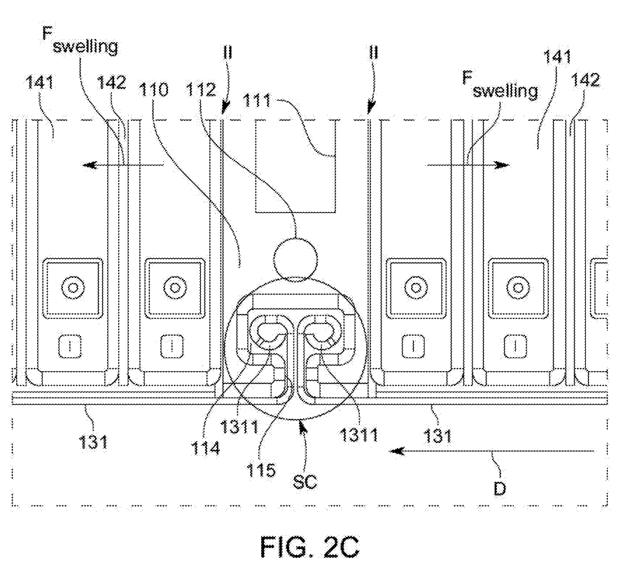

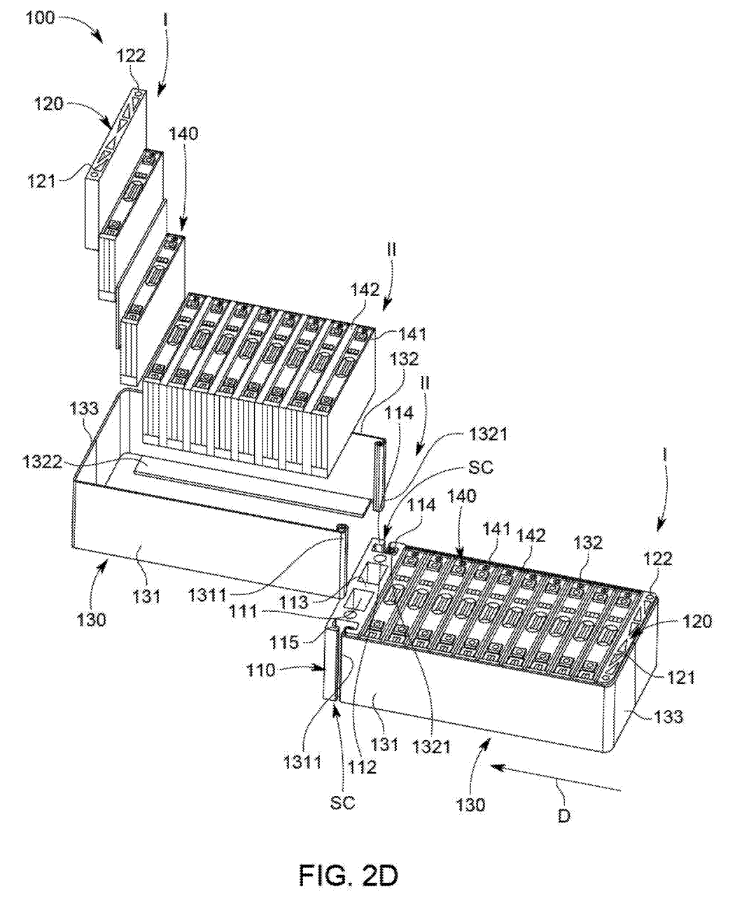

The form-fit sliding connection SC is formed between the cavity 114 and a fluidly connected slit 115 of the first end plate 110, both of which extend perpendicular to the stacking direction D, and a thickened end portion 1311, 1321 of each of the side walls 131, 132. The thickened end portions 1311, 1321 are slidable accommodated inside the cavities 114, while the side walls 131, 132 extend through the slits 115. A portion of the side walls 131, 132 including the thickened end portions 1311, 1321 is bent such that a bent portion is inclined with respect to the stacking direction D. The bent portion may extend perpendicular to the stacking direction D. The thickened end portion 1311,1321 may be a material thickening and/or geometric thickening. The geometric thickening of the thickened end portion 1311,1321 includes a spirally wound area (or part) of the side wall 131, 132 (see, e.g., FIGS. 2B to 3A). Due to the geometric thickening in the form of the spiral windings of the thickened end portions 1311, 1321, which are arranged in the cavities 114, the spiral windings do not fit through the slits 115. The arrangement may only be loosened by moving it perpendicular to the stacking direction D.

As shown in the illustrated embodiments, a first end of each of the side walls 131, 132 is connected to the first end plate 110 by the form-fit sliding connection SC.

FIG. 2A is a schematic perspective view of a battery module 100 according to another embodiment. The battery module 100 includes two battery cell stacks 140 and two module walls 130. The first end plate 110 is arranged between the two battery cell stacks 140. The battery cell stacks 140 are identical in construction but in other embodiments may differ from one another. The first end plate 110 acts as a middle plate and is arranged centrally between a first end of the battery module 100 and a second end of the battery module 100.

Components that are identical to those in FIG. 1 are not described again or are only briefly described because the description of these components is the same as described above with respect to the description of FIG. 1.

The first end plate 110 differs from that shown in FIG. 1 in that two cavities 114 are present, which extend from the slits 115 in both positive and negative stacking directions D. For example, the cavities 114 have substantially the same shape but are extended to form a larger cross-section. For example, the first end plate 110 shown in FIG. 2A is mirrored along a plane that extends parallel to the slit 115 and extends between both slits 115 so that the first end plate 110 has the same structure on both sides. In other embodiments, the two cavities 114 may each be present as two pairs of separate cavities 114, each of which is fluidically connected to a slit 115. For example, in such an embodiment the first end plate 110 has a total of four cavities 114 and four slits 115, of which two pairs of cavities 114 and slit 115 are arranged on opposite sides of the first end plate 110.

In the illustrated embodiment, the form-fit sliding connection SC is formed in that the first side wall 131 and the second side wall 132 of each of the two module walls 130 extend along a corresponding slit 115 and open into the corresponding thickened end portion 1311, 1321, which is arranged within the corresponding cavity 114 of the first end wall 110 and extends along it.

FIG. 2B is a schematic top view of the battery module 100 shown in FIG. 2A. The symmetrical structure of the battery module 100 shown in FIG. 2A along an axis of symmetry of the first end plate 110. FIG. 2C is a top view illustrating an enlarged view of a form-fit sliding connection SC shown in FIG. 2B. The geometric thickening of the thickened end portion including a spirally wound area (or part) of the side wall is illustrated. The geometric thickening may include a partial winding or a plurality of windings. These spiral windings are arranged within the cavities 114, and non-wound areas of the side walls 131, 132 extend through the slit 115. The forces occurring there are also shown to explain the connection according to embodiments of the present disclosure. The form-fit sliding connection SC prevents the thickened end portions 1311, 1321 from moving through the slits 115 due to the swelling forces F_{Swelling} that occur and/or prevent relative movement of the first end plate 110 with respect to the side walls 131, 132. However, due to the spiral windings, an initially relative movement is permitted by stretching the battery cell stack 140 by reducing the distance of the spiral windings, whereby a spring force counteracting the swelling forces F_{Swelling} is built up. At a certain point, this force exceeds the swelling forces F_{Swelling}, preventing any further change in length.

FIG. 2D is a partially exploded schematic perspective view of the battery module shown in FIG. 2A. The side walls 131, 132 have a support surface 1322 on an underside of the battery cell stack 140 extending along the stacking direction D. For example, each of the side walls 131, 132 has an area extending perpendicular to the stacking direction D and along the stacking direction D to form a receptacle, for example, rectangular, on which the battery cells 141 and spacers 142 are stored (or accommodated or rest).

FIG. 3A is a view illustrating an arrangement during a method for assembling a battery module 100 according to some embodiments. The battery module 100 in the illustrated embodiment is similar to that shown in FIG. 2A, although the same method may be used with other embodiments. In FIG. 3A, the assembly has not yet been completed. Some of the battery cells 141 and the spacers 142 are already stacked, while the rest of these components are being prepared and arranged.

FIG. 3B is a flow chart describing a method for assembling a battery module according to some embodiments.

Two battery cell stacks 140 with battery cells 141 stacked between a first end side I and a second end side II in a stacking direction D are provided in step S100. Further, in step S200, two module walls 130 are provided, with each of the module walls 130 including two side walls 131, 132 arrangeable on opposite sides of the respective battery cell stack 140 and extending along the stacking direction D and an end wall 133 arrangeable on the first end side I of the respective battery cell stack 140 and connecting the two side walls 131, 132 to each other. In step S300, the battery cell stacks 140 are compressed with an initial compression force F (see, e.g., FIG. 3A), and in step S400, the battery cell stacks 140 are arranged between the side walls 131, 132 of the respective module wall 130. In step S500, a first end plate 110 is provided, which is arrangeable on the second end side of each of the respective battery cell stack 140 and opposite the respective end wall 133 and connectable to the two respective side walls 131, 132 by a form-fit sliding connection SC operable in a sliding direction SD perpendicular to the stacking direction D. Finally, in step S600, the form-fit sliding connection SC with the two respective side walls 131, 132 is established by sliding the first end plate 110 along the sliding direction SD.

### DESCRIPTION OF SOME REFERENCE SYMBOLS

100 battery module
110 first end plate
111 recess
112 mounting hole (or opening)
113 central area/connecting bar
114 cavity
115 slit
120 second end plate
121 recess
122 mounting hole (or opening)
130 module wall
131 first side wall
1311 thickened end portion
132 second side wall
1321 thickened end portion
1322 support surface
133 end wall
140 battery cell stack
141 battery cell
142 spacer
SC form-fit sliding connection
F initial compression force
D stacking direction
SD sliding direction F_{Swelling} swelling forces

What is claimed is:

1. A battery module comprising:
a battery cell stack comprising battery cells stacked in a stacking direction between a first end side and a second end side;
a module wall comprising two oppositely arranged side walls extending along the stacking direction with the battery cell stack arranged therebetween and an end wall on the first end side of the battery cell stack and connecting the two side walls to each other; and
a first end plate on the second end side of the battery cell stack and opposite the end wall,
wherein each of the side walls is connected to the first end plate by a form-fit sliding connection, and
wherein a sliding direction of the form-fit sliding connection is perpendicular to the stacking direction.

2. The battery module as claimed in claim 1, wherein the module wall comprises a U-shaped module wall at least partially enclosing the battery cell stack.

3. The battery module as claimed in claim 1, wherein each of the side walls is connected to the end wall by a form-fit sliding connection having a sliding direction perpendicular to the stacking direction.

4. The battery module as claimed in claim 1, wherein a first end of each of the side walls is connected to the first end plate by the form-fit sliding connection.

5. The battery module as claimed in claim 1, wherein a second end of each of the side walls is connected to the end wall by the form-fit sliding connection.

6. The battery module as claimed in claim 1, wherein the module wall is integrally formed as one-piece.

7. The battery module as claimed in claim 1, wherein the form-fit sliding connection is between a cavity and a fluidly connected slit in the first end plate, both extending perpendicular to the stacking direction, and a thickened end portion of each of the side walls,
wherein the thickened end portions are slidably accommodated inside the corresponding cavity while the side walls extend through the corresponding slit.

8. The battery module as claimed in claim 7, wherein a portion of at least one of the side walls comprising the respective thickened end portion is bent such that the bent portion is inclined with respect to the stacking direction.

9. The battery module as claimed in claim 8, wherein the bent portion is perpendicular to the stacking direction.

10. The battery module as claimed in claim 7, wherein the thickened end portion is a material thickening and/or geometric thickening.

11. The battery module as claimed in claim 10, wherein the geometric thickening of the thickened end portion comprises a spirally wound area of the side wall.

12. The battery module as claimed in claim 1, wherein the side walls, the module wall, and/or the first end plate comprise a locking element configured to block displacement of the first end plate in the sliding direction after the form-fit sliding connection is established.

13. The battery module as claimed in claim 12, wherein the locking element is pivotable from a first position to a second position about a pivot axis perpendicular to the stacking direction such that, in the first position, the first end plate is displaceable, and in the second position, the first end plate is fixed.

14. The battery module as claimed in claim 1, further comprising two of the battery cell stacks and two module walls,
wherein the first end plate is arranged between the two battery cell stacks, and
wherein the first end plate is connected to each of the side walls of the respective module walls by the form-fit sliding connection.

15. The battery module as claimed in claim 1, wherein the first end plate is configured to accommodate battery module management electronics for the battery module.

16. A method for assembling a battery module as claimed in claim 1, the method comprising:
providing a battery cell stack with battery cells stacked in a stacking direction between a first end side and a second end side;
providing a module wall comprising two side walls on opposite sides of the battery cell stack and extending along the stacking direction and an end wall on the first end side of the battery cell stack to connect the two side walls to each other;
compressing the battery cell stack;
arranging the battery cell stack between the side walls of the module wall;
arranging a first end plate on the second end side of the battery cell stack and opposite the end wall to be connected to the two side walls by a form-fit sliding connection having a sliding direction perpendicular to the stacking direction; and
establishing the form-fit sliding connection with the two side walls by sliding the first end plate along the sliding direction.

17. A battery pack comprising:
a plurality of battery modules as claimed in claim 1, configured in a series, parallel, or a mixture of both;
a battery management system; and
a cooling circuit.
